(19) United States
(12) Patent Application Publication
(10) Pub. No.: US 2005/0134006 A1
(43) Pub. Date: Jun. 23, 2005

(54) Multi-layer cylinder head gasket with resilient seal

(76) Inventors: Jeffrey T. Adams, Lexington, SC (US); Mark S. Whitlow, Columbia, SC (US); James S. Hicks, Blythewood, SC (US); George Whittier, Lexington, SC (US)

Correspondence Address: John M. Harrington;Kilpatrick Stockton LLP, 1001 West Fourth Street, Winston-Salem, NC, 27101, US

(21) Appl. No.: 10/996,963

(22) Filed: Nov. 24, 2004

Related U.S. Application Data
(60) Provisional application No. 60/525,551, filed on Nov. 26, 2003.
(60) Provisional application No. 60/615,635, filed on Oct. 4, 2004.

(51) Int. Cl. F02F 11/00

(52) U.S. Cl. 277/601

(57) ABSTRACT

A head gasket assembly comprising a gasket body comprising a plurality of layers of gasket material a combustion aperture extending through said gasket body, the aperture defined by an inner periphery of the gasket, said periphery adapted to be fitted with a resilient seal element, and a resilient seal element disposed about the inner periphery of the aperture in the gasket body, said seal element being formed of a helically-wound metal wire or metal tube seal at least partially surrounded by a jacket having a flange protruding therefrom and engaging the gasket body.

### CROSS REFERENCE TO RELATED APPLICATIONS

The present application claims priority under 35 U.S.C. § 119(e) from U.S. Provisional Patent Application Ser. No. 60/525,551 filed Nov. 26, 2003, entitled “Multi-Layered Cylinder Head Gasket With Spring-Energized Seal Element”, and U.S. Provisional Patent Application Ser. No. 60/615,635 filed Oct. 4, 2004, entitled “Multi-Layered Cylinder Head Gasket With Spring-Energized Seal Element”, the disclosure of both is incorporated herein by reference.

### FIELD OF THE INVENTION

The present invention relates to gaskets for use in high performance combustion applications. More particularly the present invention relates to head gaskets for internal combustion engines in high temperature and high pressure applications.

### BACKGROUND OF THE INVENTION

Cylinder head gaskets are well known in the art for sealing the mating surfaces of an engine block and cylinder head in an internal combustion engine. Cylinder head gaskets further provide a combustion seal to maintain the high temperature and pressure within the cylinder. As such, these gaskets are subjected to harsh operating conditions, particularly in high performance engines.

One common type of such a gasket is the multi-layered steel gasket. These gaskets are formed from a plurality of overlapping plates or sheets, generally of steel. These plates provide structural support and radial strength to prevent blowouts. Examples of such gaskets are found in U.S. Pat. No. 5,803,462 and U.S. Patent Application Publication No. 2002/0170520, both of which are herein incorporated by reference. These publications demonstrate various attempts to enhance the sealing characteristics of multi-layered metal gaskets.

There are many methods of sealing combustion gases utilizing multi-layered steel technology. One common method is to emboss one or more of the individual layers to make a sealing ridge. The embossment method can have performance problems due to temperature limitations of the materials used to make the multi-layer steel gasket. Additionally, the gaskets are susceptible to blow out in the thin web area directly between different cylinder bores. Also, by using an embossment for sealing combustion gases, this will increase the bolt load requirements for an effective seal.

A second common method is to have an attached, solid, yieldable sealing element, as in U.S. Pat. No. 5,803,462. This component is typically welded, bonded, or formed to the multi-layer steel body so that the end result is a unitized assembly. This method often requires either the engine block or cylinder head to have a groove machined to accept the wire. This adds cost and is undesirable. Further by using a solid wire as the combustion seal element, the bolt load required to effect a seal is dramatically increased, which leads to distortion at the bore wall. This distortion causes decreases in engine performance.

A common failure mode of multi-layer steel gaskets is burning and erosion of the gasket between the cylinder bores. This can lead to cross over leakage, where gases from one cylinder escape to another and can even pressurize the coolant systems as the combustion gases push by the cylinder liners. These issues can decrease engine performance.

In order to provide an effective seal, prior art gaskets often require high bolt loads to secure the gasket, which can lead to distortion of the bore. Prior art gaskets are also susceptible to delamination of the layers during periods of high temperature and pressure. This can cause gasket blowout and failure of the engine.

Other attempts, for example U.S. Pat. Nos. 5,505,466 and 5,277,433, require primary and secondary combustion sealing elements. The requirement for two sealing elements is undesirable in applications with limited bore-to-bore spacing between cylinders.

It would, therefore, be desirable to provide a multi-layered gasket with a combustion seal that requires less bolt load to provide an effective seal. Further, a more resilient gasket that is not susceptible to delamination would provide a significant advantage over the prior art. Additionally, it would be desirable for this gasket to be used without requiring additional machining of either the engine block or cylinder head. This gasket should also be able to be used on engines that have limited spacing between cylinder bores. It is to these perceived needs that the present invention is directed.

### SUMMARY OF THE INVENTION

In a first aspect of the present invention, a head gasket assembly is provided comprising a gasket body comprising a plurality of layers of gasket material, a combustion aperture extending through said gasket body, the aperture defined by an inner periphery of the gasket, said periphery adapted to be fitted with a resilient seal element, and a resilient seal element disposed about the inner periphery of the aperture in the gasket body.

In one embodiment of the present invention, the seal element comprises a spring-energized seal element. In an alternate embodiment of the present invention, the seal element comprises a metal tube seal, which may optionally be pressure filled.

In a preferred embodiment of the present invention, the seal element further comprises a jacket at least partially surrounding the spring element and having a flange protruding therefrom. The jacket flange engages at least one layer of the surrounding gasket body and may be disposed between two layers of the surrounding gasket body. In another embodiment of the present invention, the jacket comprises a plurality of flanges protruding therefrom.

A further embodiment of the present invention provides a head gasket wherein the seal element is attached to said gasket body with an adhesive. Alternatively, the seal element is welded to said gasket body. Preferably, the seal element engages the gasket body through a snap-fit connection. The seal element may further be coated or plated with a polymeric coating.

In an additional embodiment of the present invention, the head gasket assembly further comprises a plurality of combustion apertures extending through said gasket body, each aperture having a seal element disposed therein.

In a still further embodiment of the present invention, the gasket body comprises three layers of gasket material, the inner most layer of gasket material having a combustion aperture of a first diameter, the two outermost layers having combustion apertures of a second diameter, and wherein said first diameter is smaller than said second diameter. The seal element comprises a jacket having two flanges configured to engage either side of said inner most layer of the gasket body.

In a second aspect of the present invention, a head gasket assembly is provided comprising a gasket body comprising a plurality of layers of gasket material a combustion aperture extending through said gasket body, the aperture defined by an inner periphery of the gasket, said periphery adapted to be fitted with a resilient seal element, and a resilient seal element disposed about the inner periphery of the aperture in the gasket body, said seal element being formed of a helically-wound metal wire at least partially surrounded by a jacket having a flange or flanges protruding therefrom and engaging the gasket body.

Thus, there has been outlined, rather broadly, the more important features of the invention in order that the detailed description that follows may be better understood and in order that the present contribution to the art may be better appreciated. There are, obviously, additional features of the invention that will be described hereinafter and which will form the subject matter of the claims appended hereto. In this respect, before explaining several embodiments of the invention in detail, it is to be understood that the invention is not limited in its application to the details and construction and to the arrangement of the components set forth in the following description or illustrated in the drawings. The invention is capable of other embodiments and of being practiced and carried out in various ways.

It is also to be understood that the phraseology and terminology herein are for the purposes of description and should not be regarded as limiting in any respect. Those skilled in the art will appreciate the concepts upon which this disclosure is based and that it may readily be utilized as the basis for designating other structures, methods and systems for carrying out the several purposes of this development. It is important that the claims be regarded as including such equivalent constructions insofar as they do not depart from the spirit and scope of the present invention.

So that the manner in which the above-recited features, advantages and objects of the invention, as well as others which will become more apparent, are obtained and can be understood in detail, a more particular description of the invention briefly summarized above may be had by reference to the embodiment thereof which is illustrated in the appended drawings, which drawings form a part of the specification and wherein like characters of reference designate like parts throughout the several views. It is to be noted, however, that the appended drawings illustrate only preferred and alternative embodiments of the invention and are, therefore, not to be considered limiting of its scope, as the invention may admit to additional equally effective embodiments.

### BRIEF DESCRIPTION OF THE DRAWINGS

FIG. 1 is a top view of a portion of a head gasket assembly in an embodiment of the present invention.

FIG. 2 is a top view of a seal element in an embodiment of the present invention.

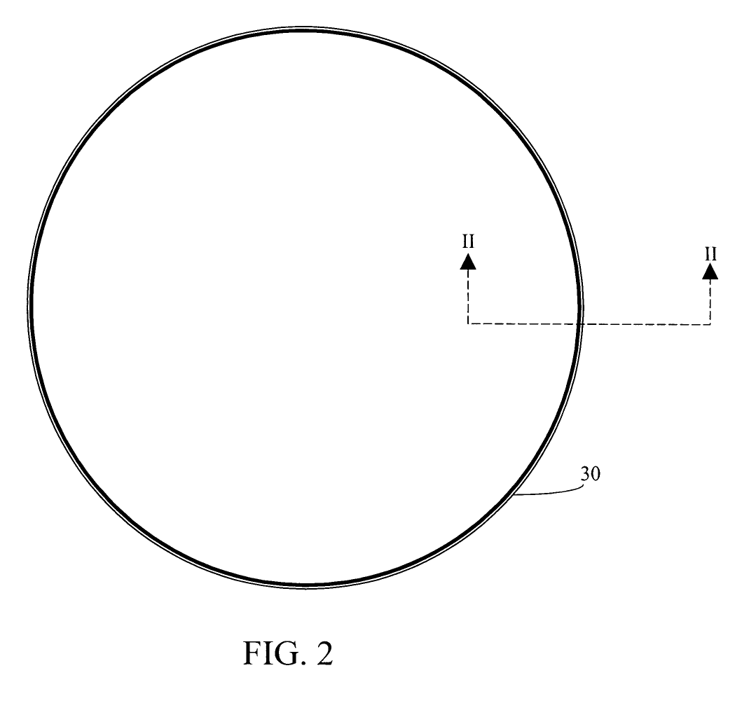

FIG. 3 is a cut-away view of the seal element of FIG. 2 taken along line II-II in an embodiment of the present invention.

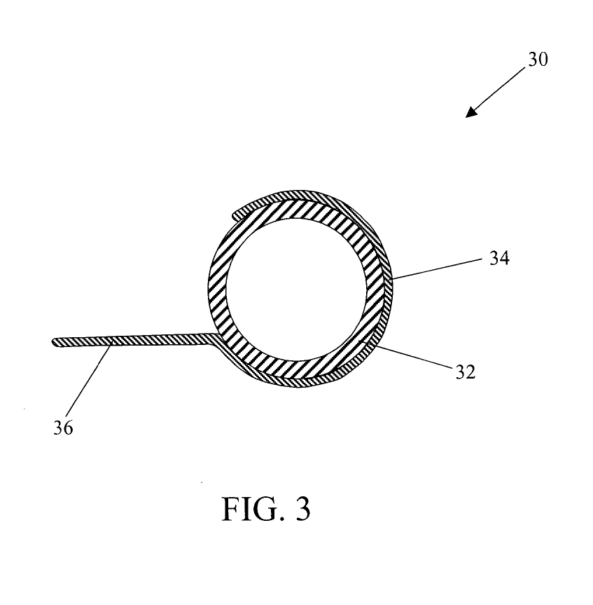

FIG. 4 is a cut away view of the head gasket assembly of FIG. 1 taken along line I-I in an embodiment of the present invention.

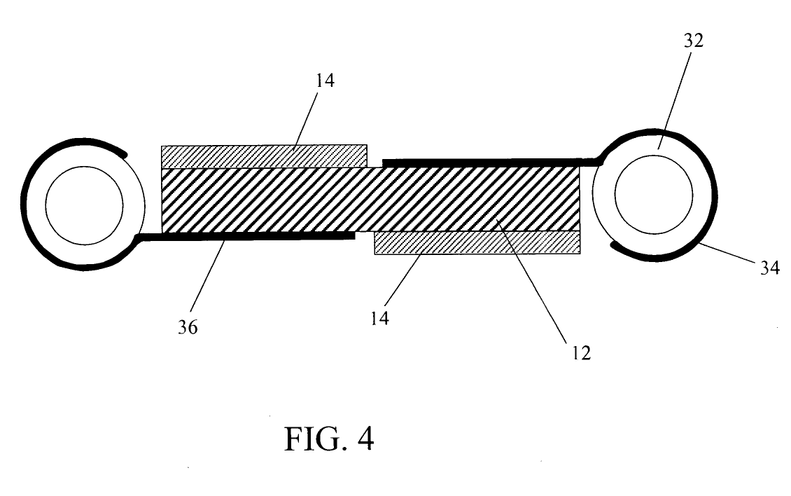

FIG. 5 is a cross sectional view of a seal element and surrounding gasket body in an embodiment of the present invention.

FIG. 6 is an isometric view of a portion of a seal element in an embodiment of the present invention.

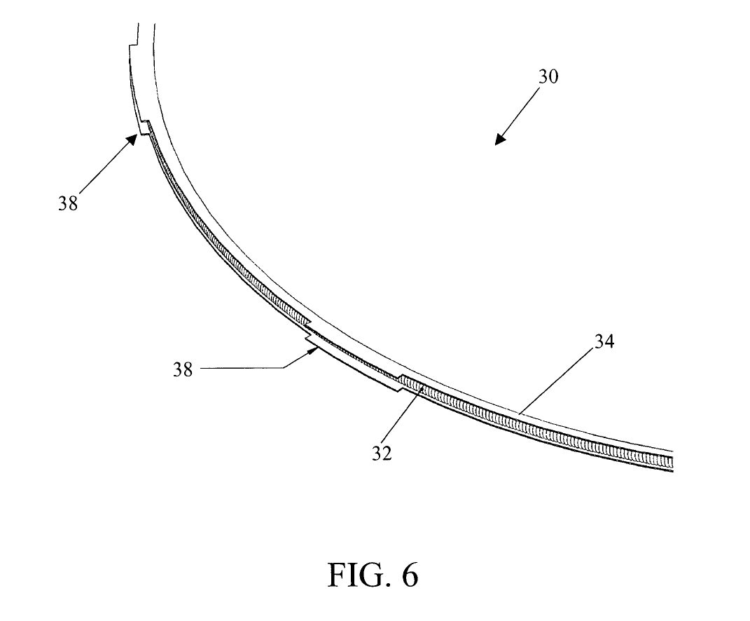

### DETAILED DESCRIPTION

In a first aspect of the present invention, a multi-layered head gasket assembly is provided comprising a plurality of layers of gasket material laminated together. The multi-layered gasket further comprises at least one aperture therethrough for mounting in conjunction with a cylinder bore. The internal periphery of the gasket at the aperture is adapted to be fitted with a resilient element for providing a seal around the aperture.

In one embodiment of the present invention, the gasket body comprises a multi-layered head gasket assembly as the primary carrier and sealing means for water/coolant and oil apertures. The multi-layered gasket may be constructed similarly to those of the prior art, but absent an integral combustion element. This gasket body is then fitted with a separate, resilient spring-energized combustion seal element.

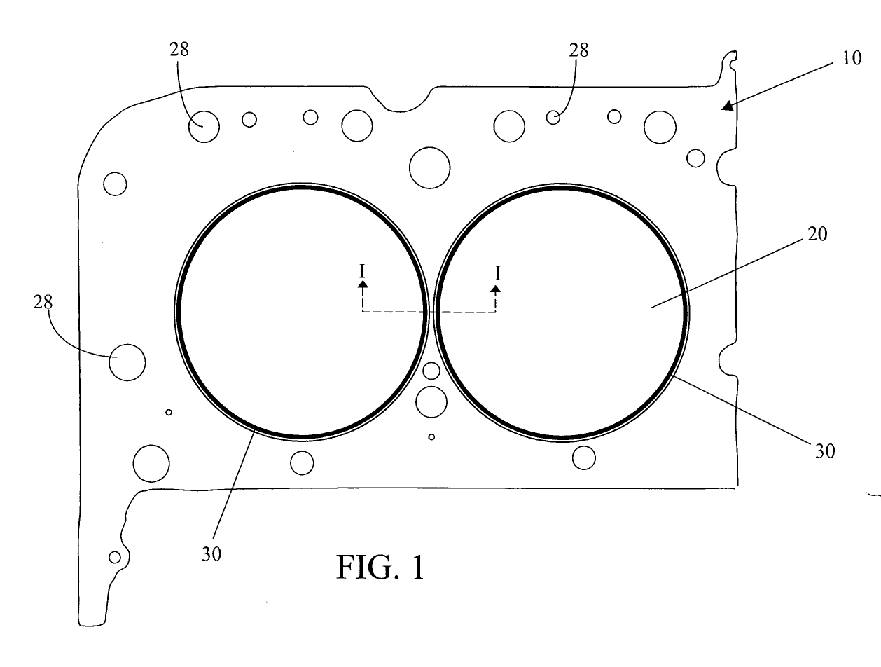

A section of a head gasket assembly in one embodiment of the present invention is shown in FIG. 1. The gasket body 10 comprises a plurality of layers of gasket material (not shown) and is formed with a plurality of apertures 20, 28 therethrough. Combustion chamber apertures 20 are provided for sealing the main cylinder bores. Two of them are shown in FIG. 1, however, in the various embodiments of the invention any number may be provided as is desirable. Additional apertures 28 may be provided for oil and coolant passages, as well as bolt holes for mounting and securing the head gasket assembly between the head and block in an engine.

In a preferred embodiment of the present invention, the multi-layered gasket body comprises layers of a rigid non-compressible material. In one preferred embodiment of the present invention, the layers comprise stainless steel. In alternate embodiments of the present invention, the gasket comprises a graphite, carbon fiber, perforated steel, or a fibrous or paper type gasket material with a solid steel core. Further, the gasket may comprise other sheet metals, such as aluminum, copper, or nickel, or alloys thereof. In one embodiment of the present invention, the gasket body is coated with a layer of Viton®, a fluoro-elastomer based on the copolymer of unylidene fluoride and hexafluoropropylene made by Dupont. In another embodiment of the present invention, the gasket body is coated with a rubberized compound to create a more effective seal for the water/coolant and oil ports. As will be appreciated by those skilled in the art, the thickness and number of the layers will vary based on the particular application and characteristics of the material used.

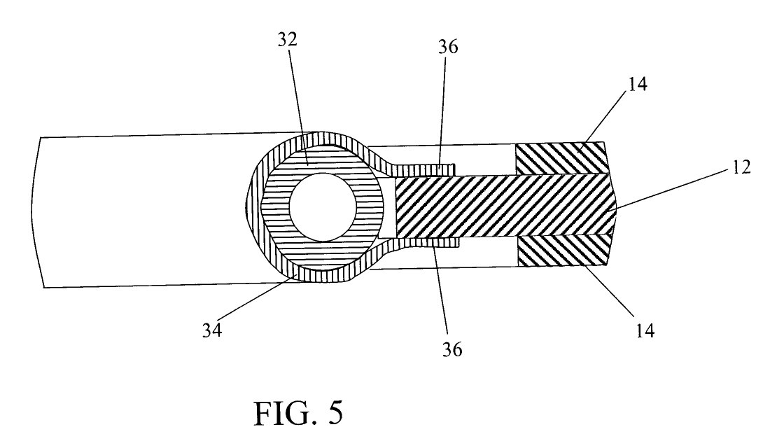

In a preferred embodiment of the present invention, illustrated in FIG. 5, the gasket body comprises at least three layers. The inner most layer 12 comprises a cylinder aperture of a first diameter. The two outermost layers 14 disposed on either side of the inner most layer comprise cylinder apertures of a second diameter where the second diameter is larger than the first diameter. In this manner, the inner most layer 12 engages the seal element through a flange or flanges 36 associated with the seal.

In a most preferred embodiment of the present invention, the seal element 30 comprises a helically wound spring 32 substantially enclosed by a jacket 34. The helically wound spring preferably comprises a circular cross section. The spring is preferably constructed of a high strength material such as Inconel® (a nickel-chromium alloy) or Elgiloy® (a cobalt-chromium-nickel alloy). The jacket protects the spring and minimizes fretting while providing a means for attaching the seal to a gasket body.

In one embodiment of the present invention, the jacket comprises a high strength material, such as stainless steel. In a further embodiment of the present invention, the jacket comprises a stainless steel alloy, preferably a nickel alloy such as Inconel®, or Haynes 25® (also known as L605—a cobalt-chromium-tungsten-nickel alloy).

In another embodiment of the present invention, the spring is coated with a polymerized coating to create a tighter seal and further prevent fretting of the spring. One such preferred polymerized coating is a polytetrafluoroethylene (PTFE) based coating. In another embodiment of the present invention, the jacket is coated with a metallic or polymer coating in order to reduce friction and improve the sealing level.

In an additional embodiment of the present invention, the seal element 30 is attached to the gasket body 10 through a flange 36 that protrudes from the seal 30 and engages the gasket body. In one embodiment of the present invention, the flange comprises extension of the spring, or preferably, an extension of the jacket 34 surrounding the spring 32. The flange 36 is then disposed upon at least one layer 12 of the multi layer gasket body. However, in another embodiment of the present invention, the flange engages two layers of the gasket body and is housed therebetween.

In a further embodiment of the present invention, the spring-energized seal element is provided with a plurality of tabs 38 in the jacket 34 for engaging one or more layers of the gasket material 10. Each tab 28 comprises a further extension of the jacket 34 over a portion of the circumference of the seal. In a preferred embodiment of the present invention, the plurality of tabs are arranged about the circumference of the seal with approximately equal spacing between them.

In another embodiment of the present invention, illustrated in FIG. 5, the spring element 32 is housed within a jacket 34 which extends substantially around the entire circumference of the spring element and ends in two flanges 36. The two flanges preferably protrude parallel to one another and engage an inner most layer 12 of the surrounding gasket material.

Additionally, the spring-energized seal element may be manufactured with multiple jacket layers or comprise different types of wire springs. The spring-energized seal element may also have multiple wraps for sealing or multiple flanges for attachment. In embodiments comprising multiple flanges, the flanges may come off at different angles to provide multi-directional support.

Further means for attaching the spring-energized seal element to the gasket comprise welding the seal into place or affixing the seal with an adhesive to the gasket body. Additionally, in a most preferred embodiment of the present invention, the spring-energized seal forms a snap-fit connection with the gasket body or other type of interference type fit to provide a solution that needs neither welding nor adhesives.

The spring-energized seals of the present invention provide a level of sealing that exceeds all current combustion sealing elements of traditional head gasket technology. The seal element requires less bolt load to effect a proper seal and therefore minimizes bore distortion upon installation. The spring-energized combustion seal element of the present invention is also more resistant to higher combustion peak pressures and temperatures.

A further feature and advantage of the present invention is the spring-energized combustion seal element requires no secondary combustion sealing element. The result is a multi-layered steel gasket body coupled with a more resilient and less distorting combustion seal element that can withstand higher pressures, more head to block lift-off, and resists flame cutting due to the high strength alloys it is constructed from.

In a further aspect of the present invention, the combustion seal element's spring core in the previously described “spring energized seal” is replaced with a metal tube core. This seal is a hollow tubular seal with a circular shaped cross-section. In alternate embodiments of the present invention, the metal tube seal may be self-energized by system pressure or pressure filled. Depending on the application, a metal tube seal can be preferable to spring energized seals. Other resilient metal formed or machined seals may also be used as the combustion seal element like C-type cross sections, E-type, U-type or V-type where the resilient seals may be attached, bonded, welded or otherwise affixed to the gasket body.

The gaskets and seals of the present invention are particularly beneficial for high performance engines typically found in racing applications for boats, cars, motorcycles, karts, and other internal combustion engines.

Although the present invention has been described with reference to particular embodiments, it should be recognized that these embodiments are merely illustrative of the principles of the present invention. Those of ordinary skill in the art will appreciate that the seals and gaskets of the present invention may be constructed and implemented in other ways and embodiments. Accordingly, the description herein should not be read as limiting the present invention, as other embodiments also fall within the scope of the present invention.

1. A head gasket assembly comprising:
a gasket body comprising a plurality of layers of gasket material;
a combustion aperture extending through said gasket body, the aperture defined by an inner periphery of the gasket, said periphery adapted to be fitted with a resilient seal element; and
a resilient seal element disposed about the inner periphery of the aperture in the gasket body.

2. The head gasket assembly of claim 1, wherein the seal element comprises a spring-energized seal element.

3. The head gasket assembly of claim 1, wherein the seal element comprises a metal tube seal.

4. The head gasket assembly of claim 3, wherein the seal element is pressure filled.

5. The head gasket assembly of claim 1, wherein the seal element further comprises a jacket at least partially surrounding the spring element and having a flange protruding therefrom.

6. The head gasket assembly of claim 5, wherein said jacket flange engages at least one layer of the surrounding gasket body.

7. The head gasket assembly of claim 5, wherein said jacket flange is disposed between two layers of the surrounding gasket body.

8. The head gasket assembly of claim 5, wherein the jacket comprises a plurality of flanges protruding therefrom.

9. The head gasket assembly of claim 1, wherein the seal element is attached to said gasket body with an adhesive.

10. The head gasket assembly of claim 1, wherein the seal element is welded to said gasket body.

11. The head gasket assembly of claim 1, wherein the seal element engages the gasket body through a snap-fit connection.

12. The head gasket assembly of claim 1, wherein the seal element is coated with a polymeric coating.

13. The head gasket assembly of claim 1, further comprising a plurality of combustion apertures extending through said gasket body, each aperture having a seal element disposed therein.

14. The head gasket of claim 1, wherein the gasket body comprises three layers of gasket material, the inner most layer of gasket material having a combustion aperture of a first diameter, the two outermost layers having combustion apertures of a second diameter, and wherein said first diameter is smaller than said second diameter.

15. The head gasket of claim 14, wherein said seal element comprises a jacket having two flanges configured to engage either side of said inner most layer of the gasket body.

16. A head gasket assembly comprising:
a gasket body comprising a plurality of layers of gasket material;
a combustion aperture extending through said gasket body, the aperture defined by an inner periphery of the gasket, said periphery adapted to be fitted with a resilient seal element; and
a resilient seal element disposed about the inner periphery of the aperture in the gasket body, said seal element being formed of a helically-wound metal wire at least partially surrounded by a jacket having a flange protruding therefrom and engaging the gasket body.

17. A head gasket assembly comprising:
a gasket body comprising a plurality of layers of gasket material;
a combustion aperture extending through said gasket body, the aperture defined by an inner periphery of the gasket, said periphery adapted to be fitted with a resilient seal element; and
a resilient seal element disposed about the inner periphery of the aperture in the gasket body, said seal element being formed of a metal tube seal at least partially surrounded by a jacket having a flange protruding therefrom and engaging the gasket body.
